(19) United States
(12) Patent Application Publication
(10) Pub. No.: US 2023/0106242 A1
(43) Pub. Date: Apr. 6, 2023

(54) METHOD AND APPARATUS FOR VIDEO ENCODING AND DECODING

(71) Applicant: InterDigital VC Holdings France, Cesson Sevigne (FR)

(72) Inventors: Karam Naser, Mouazé (FR); Fabrice Le Leannec, Betton (FR); Tangi Poirier, Thorigné-Fouillard (FR); Michel Kerdranvat, Chantepie (FR)

(21) Appl. No.: 17/910,108

(22) PCT Filed: Mar. 9, 2021
(86) PCT No.: PCT/EP2021/055898

§ 371 Date: Sep. 8, 2022

(30) Foreign Application Priority Data
Mar. 12, 2020 (EP) 20305256.8
Mar. 13, 2020 (EP) 20305265.9
Apr. 10, 2020 (EP) 20315154.3
May 20, 2020 (EP) 20305530.6
May 26, 2020 (EP) 20305544.7

(51) Int. Cl. H04N 19/12; H04N 19/157; H04N 19/176; H04N 19/70; H04N 19/60

(52) U.S. Cl. CPC H04N 19/12; H04N 19/157; H04N 19/176; H04N 19/70; H04N 19/60

(57) ABSTRACT

Different implementations are described, particularly implementations for video encoding and decoding are presented. Accordingly, the encoding or decoding comprises obtaining a residual coding mode of a block of a picture, wherein the residual coding mode is one of regular residual coding mode (RRC) or transform skip residual coding mode (TSRC); decoding the block of the picture according to the obtained residual coding mode. According to a particular characteristic, the residual coding mode is set to regular residual coding mode (RRC) when transform skip is disabled. According to another particular characteristic, the residual coding mode is decoded from a syntax element when transform skip is enabled.

### TECHNICAL FIELD

At least one of the present embodiments generally relates to, e.g., a method or an apparatus for video encoding or decoding, and more particularly, to a method or an apparatus comprising obtaining a residual coding mode of a block of a picture.

### BACKGROUND

The domain technical field of the one or more implementations is generally related to video compression. At least some embodiments relate to improving compression efficiency compared to existing video compression systems such as HEVC (HEVC refers to High Efficiency Video Coding, also known as H.265 and MPEG-H Part 2 described in “ITU-T H.265 Telecommunication standardization sector of ITU (10/2014), series H: audiovisual and multimedia systems, infrastructure of audiovisual services—coding of moving video, High efficiency video coding, Recommendation ITU-T H.265”), or compared to under development video compression systems such as VVC (Versatile Video Coding, a new standard being developed by JVET, the Joint Video Experts Team).

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

Among coding tool tools used in HEVC and in VVC, the transform skip (TrSkip) allows the encoder to bypass the transform stage if the transform is not providing coding benefit. According to an example, bypassing the transform is useful for screen contents where the statistics of the residuals do not fit with the transform characteristics. According to another example, transform is also bypassed for lossless coding, since the transform (and quantization) results in a lossy coding mode. Besides, compared to HEVC, VVC introduced a new mode for coding residuals resulting from transform skip. That is, the residual coefficients are coded differently for regular blocks and for transform skip blocks. It is desirable to optimize the high-level syntax (HLS) of the transform skip coding regarding the different possible coding modes of a content.

### SUMMARY

The purpose of the invention is to overcome at least one of the disadvantages of the prior art. For this purpose, according to a general aspect of at least one embodiment, a method is presented. The method comprises decoding a syntax element indicating whether transform skip data are present in a bitstream; responsive to transform skip data being present, decoding at least one syntax data element related to a residual coding mode of a block of a picture, wherein the residual coding mode is one of regular residual coding mode or transform skip residual coding mode.

According to another general aspect of at least one embodiment, a method is presented. The method comprises encoding a syntax element indicating whether transform skip data are present in a bitstream; responsive to transform skip data being present, encoding at least one syntax data element related to a residual coding mode of a block of a picture, wherein the residual coding mode is one of regular residual coding mode or transform skip residual coding mode.

According to another general aspect of at least one embodiment, an apparatus is presented. The apparatus comprises one or more processors, wherein the one or more processors are configured to decode a syntax element indicating whether transform skip data are present in a bitstream; responsive to transform skip data being present, decode at least one syntax data element related to a residual coding mode of a block of a picture, wherein the residual coding mode is one of regular residual coding mode 0 or transform skip residual coding mode.

According to another general aspect of at least one embodiment, an apparatus is presented. The apparatus comprises one or more processors, wherein the one or more processors are configured for to encode a syntax element indicating whether transform skip data are present in a bitstream; responsive to transform skip data being present, encode at least one syntax data element related to a residual coding mode of a block of a picture; wherein the residual coding mode is one of regular residual coding mode or transform skip residual coding mode.

According to another general aspect of at least one embodiment, a method for encoding is presented. The encoding method comprises obtaining a residual coding mode of a block of a picture, wherein the residual coding mode is one of regular residual coding mode (RRC) or transform skip residual coding mode (TSRC); encoding the block of the picture according to the obtained residual coding mode. According to a particular characteristic, obtaining the residual coding mode of the block comprises encoding at least one syntax data element relating to a residual coding mode of a block of a picture when transform skip is enabled. According to another particular characteristic, obtaining the residual coding mode of the block comprises setting residual coding mode to regular residual coding mode (RRC) when transform skip is disabled. Advantageously, the regular residual coding mode (RRC) or transform skip residual coding mode (TSRC) is not encoded when transform skip is disabled.

According to another general aspect of at least one embodiment, a method for decoding is presented. The decoding method comprises obtaining a residual coding mode of a block of a picture, wherein the residual coding mode is one of regular residual coding mode (RRC) or transform skip residual coding mode (TSRC); decoding the block of the picture according to the obtained residual coding mode. According to a particular characteristic, obtaining the residual coding mode of the block comprises decoding at least one syntax data element relating to a residual coding mode of a block of a picture when transform skip is enabled.

According to another particular characteristic, obtaining the residual coding mode of the block comprises setting residual coding mode to regular residual coding mode (RRC) when transform skip is disabled. As for the encoding method, the regular residual coding mode (RRC) or transform skip residual coding mode (TSRC) is implicitly decoded when transform skip is disabled.

According to another general aspect of at least one embodiment, an apparatus for encoding is presented comprising means for implementing any one of the embodiments of the encoding method.

According to another general aspect of at least one embodiment, an apparatus for decoding is presented comprising means for implementing any one of the embodiments of the decoding method.

According to another general aspect of at least one embodiment, an apparatus for encoding is provided, comprising one or more processors, and at least one memory. The one or more processors is configured to implement any one of the embodiments of the encoding method.

According to another general aspect of at least one embodiment, an apparatus for decoding is provided, comprising one or more processors and at least one memory. The one or more processors is configured to implement any one of the embodiments of the decoding method.

According to another general aspect of at least one embodiment, at least one syntax data element is encoded or decoded wherein the at least one syntax data element relates to enabling transform skip of at least one region of a picture; and the block of the picture is encoded or decoded according to the obtained residual coding mode when intra sub-partition split type is set to no_split.

According to another general aspect of at least one embodiment, at least one syntax data element is encoded or decoded wherein the at least one syntax data element relates to enabling transform skip of at least one region of a picture when intra sub-partition (ISP) is enabled and transform skip is enabled. According to another general aspect of at least one embodiment, the at least one high level syntax element enabling transform skip of at least one region of a picture when intra sub-partition (ISP) is enabled and transform skip is enabled is signaled in the Sequence Parameter Set (SPS).

According to another general aspect of at least one embodiment, at least one syntax data element is encoded or decoded wherein the at least one syntax data element relates to enabling transform skip of at least one region of a picture; and the block of the picture is encoded or decoded according to the obtained residual coding mode when transform skip is enabled for ISP and intra sub-partition split type set to no_split.

According to another general aspect of at least one embodiment, the block of the picture is encoded or decoded according to the obtained residual coding mode when transform skip enabled for ISP and intra sub-partition split type set to no_split.

According to another general aspect of at least one embodiment, at least one syntax data element is encoded or decoded wherein one syntax data element relates to a constraint enabling transform skip coding mode (TRskip) and one syntax data element relates to defining a constraint enabling transform skip residual coding mode (TSRC) when the constraint enables transform skip coding mode (TRskip).

According to another general aspect of at least one embodiment, at least one syntax data element is encoded or decoded wherein at least one syntax data element relates to defining a constraint enabling transform skip residual coding mode (TSRC).

According to another general aspect of at least one embodiment, at least one syntax data element is encoded or decoded wherein the at least one syntax data element relates to enabling transform skip residual coding of at least one region of a picture; and wherein obtaining the residual coding mode further comprises decoding at least one syntax data element related to a residual coding mode of a block of a picture when transform skip residual coding is enabled. According to another general aspect of at least one embodiment, the at least one syntax data element related to enabling transform skip residual coding of at least one region of a picture is signaled in the Sequence Parameter Set (SPS).

According to another general aspect of at least one embodiment, a non-transitory computer readable medium is presented containing data content generated according to the method or the apparatus of any of the preceding descriptions.

According to another general aspect of at least one embodiment, a signal is provided comprising video data generated according to the method or the apparatus of any of the preceding descriptions.

One or more of the present embodiments also provide a computer readable storage medium having stored thereon instructions for encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1a illustrates an example of a decoding method according to a general aspect of at least one embodiment;

FIG. 1b illustrates another example of a decoding method according to a general aspect of at least one embodiment;

FIG. 1c illustrates another example of a decoding method according to a general aspect of at least one embodiment;

FIG. 2 illustrates an example of an encoding method according to a general aspect of at least one embodiment;

FIG. 3 illustrates a block diagram of an embodiment of video encoder in which various aspects of the embodiments may be implemented;

FIG. 4 illustrates a block diagram of an embodiment of video decoder in which various aspects of the embodiments may be implemented;

FIG. 5 illustrates a block diagram of an example apparatus in which various aspects of the embodiments may be implemented.

### DETAILED DESCRIPTION

It is to be understood that the figures and descriptions have been simplified to illustrate elements that are relevant for a clear understanding of the present principles, while eliminating, for purposes of clarity, many other elements found in typical encoding and/or decoding devices. It will be understood that, although the terms first and second may be used herein to describe various elements, these elements should not be limited by these terms. These terms are only used to distinguish one element from another.

The various embodiments are described with respect to the encoding/decoding of a picture. They may be applied to encode/decode a part of picture, such as a slice or a tile, or a whole sequence of pictures. Besides, various embodiments are described with respect to the decoding of blocks (for example a coding unit CU)) and are easily derived to the coding of blocks.

Various methods are described above, and each of the methods comprises one or more steps or actions for achieving the described method. Unless a specific order of steps or actions is required for proper operation of the method, the order and/or use of specific steps and/or actions may be modified or combined.

First, several embodiments of a method for encoding or decoding a picture according to the present principles are disclosed, then additional information and generic embodiments implementing the disclosed method are presented.

At Least One Embodiment for Encoding or Decoding Using Transform Skip Tools

While encoding a picture into bitstream, the prediction residual or residual, which remains between original content and its prediction, is transformed and quantized, and the quantized coefficients are entropy coded into the bitstream. The transform eliminates spatial redundancy and quantization throws out unimportant details. Among coding tool tools used in HEVC and in VVC, transform skip (TrSkip) allows the encoder to bypass the transform stage for lossless coding if the transform is not providing coding benefit. In particular, for screen content coding (SCC) relative to the coding of graphics and more generally to non-camera-captured video, block differential pulse coded modulation (BDPCM) takes advantage of repeating patterns in graphics in the same picture to remove content redundancy by coding the differential between the residual and its previously coded residual. In these modes, the Transform Skip/BDPCM Residual Coding (TSRC) allows different residual coding scheme compared to regular residual coding (RRC) mode.

In a latest version of VVC, a slice level flag slice_ts_residual_coding_disabled_flag is introduced to switch between TSRC and RRC in case of TrSkip. That is, a TrSkip coding unit (TrSkip CU) is either coded using the regular coding mode (RRC) if this flag is set to one, or coded using the transform skip coding mode (TSRC) if the flag is set to 0. This mode advantageously enables lossless mode with RRC, where TrSkip mode is signaled and RRC is used with quantization parameter less than or equal to 4, such that both transform and quantization are bypassed. Similarly, this mode allows a BDPCM CU to be coded with RRC while previously a BDPCM CU was always coded using TSRC. In the following, the high level signaling of Transform Skip mode (TrSkip) and block differential pulse coded modulation (BDPCM) in a version of VVC is described. TrSkip and BDPCM are controlled by SPS flags, where BDPCM is conditioned on the activation of TrSkip as described in the table below:

| | Descriptor |
|---|---|
| seq_parameter_set_rbsp( ) { | |
| ... | |
| sps_transform_skip_enabled_flag | u(1) |
| if( sps_transform_skip_enabled_flag ) { | |
| log2_transform_skip_max_size_minus2 | ue(v) |
| sps_bdpcm_enabled_flag | u(1) |
| } | |
| ... | |
| if( sps_transform_skip_enabled_flag \|\| | |
| sps_palette_enabled_flag ) | |
| min_qp_prime_ts_minus4 | ue(v) |
| ... | |
| } | |

Where log2_transform_skip_max_size_minus2 specifies the maximum block size of transform skip as described in a version of VVC:

log2_transform_skip_max_size_minus2 specifies the maximum block size used for transform skip, and shall be
in the range of 0 to 3, inclusive.
The variable MaxTsSize is set equal to 1 << (log2_transform_skip_max_size_minus2 + 2 ).

And where min_qp_prime_ts_minus4 determines the minimum quantization parameter in case of transform skip and palette mode (wherein palette mode is used in screen content coding to code a content using an index of a color among a limited number of colors) as follows:

min_qp_prime_ts_minus4 specifies the minimum allowed quantization parameter for transform skip mode as
follows:

| | |
|---|---|
| QpPrimeTsMin = 4 + min_qp_prime_ts_minus4 | (64) |

The value of min_qp_prime_ts_minus4 shall be in the range of 0 to 48, inclusive.

As exposed before, the switching between RRC and TSRC is done in the slice level using the flag slice_ts_residual_coding_disabled_flag:

| | Descriptor |
|---|---|
| slice_header( ) { | |
| ... | |
| slice_ts_residual_coding_disabled_flag | u(1) |
| ... | |
| } | |

Where this flag is defined as:

sp for the current slice, slice_ts_residual_coding_disabled_flag equal to 0 specifies that the residual_ts_coding( )
syntax structure is used to parse the residual samples of a transform skip block for the current slice. When
slice_ts_residual_coding_disabled_flag is not present, it is infered to be equal to 0.

The coding of BDPCM is performed at CU level:

| | Descriptor |
|---|---|
| coding_unit( x0, y0, cbWidth, cbHeight, cqtDepth, treeType, modeType ) { | |
| ... | |
| if( CuPredMode[ chType ][ x0 ][ y0 ] = = MODE_INTRA \|\| | |
| CuPredMode[ chType ][ x0 ][ y0 ] = = MODE_PLT ) { | |
| if( treeType = = SINGLE_TREE \|\| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| ... | |
| } | |
| } | |
| } | |
| if( ( treeType = = SINGLE_TREE \|\| treeType = = DUAL_TREE_CHROMA ) && | |
| ChromaArrayType != 0 ) { | |
| if( pred_mode_plt_flag && treeType = = DUAL_TREE_CHROMA ) | |
| palette_coding( x0, y0, cbWidth / SubWidthC, cbHeight / SubHeightC, treeType ) | |
| else if( !pred_mode_plt_flag ) { | |
| if( !cu_act_enabled_flag ) { | |
| if( cbWidth / SubWidthC <= MaxTsSize && cbHeight / SubHeightC <= MaxTsSize | |
| && sps_bdpcm_enabled_flag ) { | |
| intra_bdpcm_chroma_flag | ae(v) |
| if( intra_bdpcm_chroma_flag ) | |
| intra_bdpcm_chroma_dir_flag | ae(v) |
| } else { | |
| ... | |
| } | |

While TrSkip and switching between RRC and TSRC is done at transform unit level, using the slice level flag slice_ts_residual_coding_disabled_flag:

| | Descriptor |
|---|---|
| transform_unit( x0, y0, tbWidth, tbHeight, treeType, subTuIndex, chType ) { | |
| ... | |
| if( tu_cbf_luma[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT ) && !cu_sbt_flag ) | |
| transform_skip_flag[ x0 ][ y0 ][ 0 ] | ae(v) |
| if( !transform_skip_flag[ x0 ][ y0 ][ 0 ] \|\| slice_ts_residual_coding_disabled_flag ) | |
| residual_coding( x0, y0, Log2( tbWidth ), Log2( tbHeight ), 0 ) | |
| else | |
| residual_ts_coding( x0, y0, Log2( tbWidth ), Log2( tbHeight ), 0 ) | |
| } | |
| if( tu_cbf_cb[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ) | |
| transform_skip_flag[ xC ][ yC ][ 1 ] | ae(v) |
| if( !transform_skip_flag[ xC ][ yC ][ 1 ] \|\| slice_ts_residual_coding_disabled_flag ) | |
| residual_coding( xC, yC, Log2( wC ), Log2( hC ), 1 ) | |
| else | |
| residual_ts_coding( xC, yC, Log2( wC ), Log2( hC ), 1 ) | |
| } | |
| if( tu_cbf_cr[ xC ][ yC ] && treeType != DUAL_TREE_LUMA && | |
| !( tu_cbf_cb[ xC ][ yC ] && tu_joint_cbcr_residual_flag[ xC ][ yC ] ) ) { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| if( !transform_skip_flag[ xC ][ yC ][ 2 ] \|\| slice_ts_residual_coding_disabled_flag ) | |
| residual_coding( xC, yC, Log2( wC ), Log2( hC ), 2 ) | |
| else | |
| residual_ts_coding( xC, yC, Log2( wC ), Log2( hC ), 2 ) | |
| } | |
| } | |

However, this slice level flag slice_ts_residual_coding_disabled_flag created some ambiguity in controlling the transform skip as a tool to bypass the transform and transform skip residual coding or as an alternative coding method for residuals. Indeed, the transform skip is controlled by an SPS flag (sps_transform_skip_enabled_flag) and TSRC is controlled at the slice level (slice_ts_residual_coding_disabled_flag). The two flags are coded independently, which results in 4 possibilities:
1) Both TrSkip and TSRC are activated: This is the default case in VTM common testing condition, in which transform can be bypassed and the subsequent residual coefficients are coded using TSRC;
2) Both TrSkip and TSRC are deactivated: This is a mode where transform skip is completely deactivated. In this case, no transform is bypassed and TSRC is never used.
3) TrSkip is activated and TSRC is deactivated: This is current method for lossless coding of natural content in VTM. In this case, the transform can be skipped, but RRC is used for the subsequent residual coefficients.
4) TrSkip is deactivated and TSRC is activated: This is allowed in WC, but it is a useless mode. Indeed, if TrSkip is not allowed, no transform is bypassed and therefore whether TSRC is activated or not it will not be used. This is in contradictory with the VVC design, where a contradictory signaling should be avoided.

Additionally, for defining profiles, VVC has several constraint flags. For TrSkip, the constraint flag no_transform_skip_constraint_flag is used. If it is set to one, transform skip is disabled by the corresponding SPS flag. This corresponds to a profile where transform skip is not implemented by the decoder. For example, the profiling is done via the following constraint flags:

| | Descriptor |
|---|---|
| general_constraint_info( ) { | |
| no_transform_skip_constraint_flag | u(1) |
| no_bdpcm_constraint_flag | u(1) |
| ... | |
| } | |

Where the semantics of the TrSkip constraint flag are:

no_transform_skip_constraint_flag equal to 1 specifies that sps_transfrom_skip_enabled_flag shall be equal
to 0. no_transform_skip_constraint_flag equal to 0 does not impose such a constraint.

However, in case TrSkip is activated, TSRC is implemented although not used. For example, TrSkip is useful for a profile that supports lossless but, in that case, TSRC is not implemented. An efficient implementation of this lossless mode is therefore desirable.

Finally, another tool related to transform tools is Intra Sub-Partitions (ISP) wherein, for Transform Unit (TU), ISP use the reconstructed samples of each sub-partition that are available to generate the prediction of the next sub-partition. Indeed, a CU is split into 2 or 4 sub-partitions when ISP is enabled, in either horizontal or vertical direction. However, transform skip is not activated with ISP and thus, ISP mode is not compatible with lossless coding. This limitation was acceptable because TSRC does not fit well ISP residuals for common testing conditions, and the cost of signaling two modes (TrSkip or not) seems to be higher than the benefit of TSRC. However, with the adoption of slice_ts_residual_coding_disabled_flag, it is desirable to enable ISP for lossless with RRC.

Therefore, at least one embodiment for encoding or decoding using transform skip tools advantageously avoids coding slice_ts_residual_coding_disabled_flag if transform skip is disabled. At least one variant embodiment for encoding or decoding using transform skip tools advantageously enables ISP for lossless mode. At least one variant embodiment for encoding or decoding using transform skip tools allows BDPCM regardless of TrSkip since it can be coded with RRC. And, at least one variant embodiment for encoding or decoding using transform skip tools adds a constraint flag to enable a profile that allows lossless without TSRC.

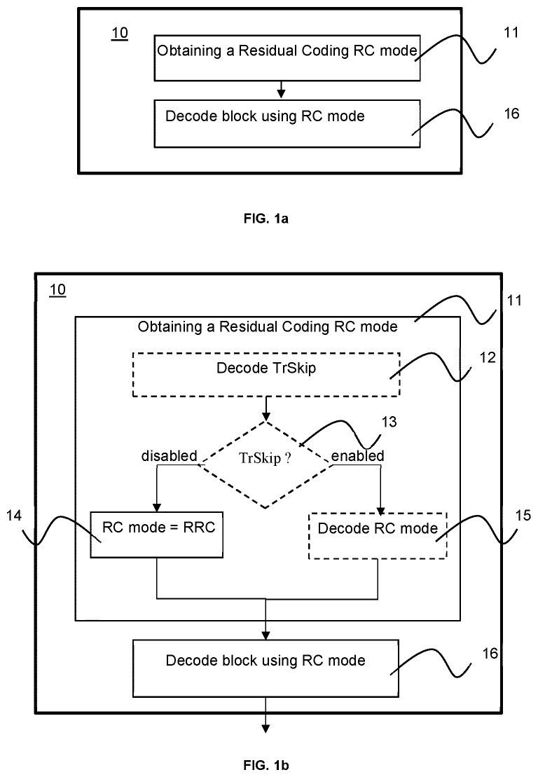

FIG. 1a illustrates an example of decoding method according to a general aspect of at least one embodiment. In the following, the different embodiments for signaling/deriving transform tools and coding modes are described for a decoding method, but the present principles will be easily derived for an encoding method by the skilled in the art. Thus, the method 10 for decoding a block (for example a Coding Unit CU) in a picture comprises, in a step 11, obtaining a residual coding mode, RC mode. As previously described, the residual coding mode is one of regular residual coding mode RRC or transform skip residual coding mode TSRC. The RC mode is applied while decoding 16 the block of the picture to control entropy coding of a residual of the block. According to a particular characteristic, the residual coding mode is set to regular residual coding mode RRC when transform skip is disabled. This embodiment advantageously avoids coding slice_ts_residual_coding_disabled_flag if transform skip is disabled. According to another particular characteristic, the residual coding mode is decoded from slice_ts_residual_coding_disabled_flag when transform skip is enabled.

FIG. 1b illustrates another example of a decoding method according to a general aspect of at least one embodiment. According to a particular characteristic, in a step 12, the method comprises decoding the SPS flag enabling or disabling the transform skip tool sps_transform_skip_enabled_flag. In a step 13, TrSkip is tested using the decoded value of the sps_transform_skip_enabled_flag. In case, the TrSkip is disabled, no transform is bypassed therefore TSRC will not be used and thus, in a step 14, RC mode is set to RRC. In case, the TrSkip is enabled, the residual coding mode is controlled by the decoded value of the slice_ts_residual_coding_disabled_flag in a step 15. Accordingly, If TrSkip is disabled at SPS level, there is no need to code slice_ts_residual_coding_disabled_flag as the transform will never be bypassed. In other word, the slice_ts_residual_coding_disabled_flag is implicitly decoded when TrSkip is deactivated. The VVC specification is therefore modified as follows in the slice header (underlined):

| | Descriptor |
|---|---|
| slice_header( ) { | |
| ... | |
| if (sps_transform_skip_enabled_flag) { | |
| slice_ts_residual_coding_disabled_flag | u(1) |
| } | |
| ... | |
| } | |

FIG. 1c illustrates another example of a decoding method according to a general aspect of at least one embodiment. This exemplary method is an alternative to the step 11 of FIG. 1B for obtaining the residual coding mode. According to a particular characteristic, in a step 12, the method comprises decoding the SPS flag enabling or disabling the transform skip tool sps_transform_skip_enabled_flag (TrSkip) where more specifically the sps_transform_skip_enabled_flag is defined as:

sps_transform_skip_enabled_flag equal to 1 specifies that transform_skip_flag could be present in the transform unit syntax. sps_transform_skip_enabled_flag equal to 0 specifies that transform_skip_flag is not present in the transform unit syntax.

In a step 13, TrSkip is tested using the decoded value of the sps_transform_skip_enabled_flag. In case, the TrSkip is enabled, that is sps_transform_skip_enabled_flag specifies that transform_skip_flag could be present in the transform unit syntax, the slice_ts_residual_coding_disabled_flag is decoded in a step 15, and the residual coding mode is set according to the decoded value of slice_ts_residual_coding_disabled_flag. Otherwise, the residual coding mode is implicitly derived, and for instance set to regular residual coding mode RRC. In other word, the slice_ts_residual_coding_disabled_flag is only decoded when TrSkip is activated. Although not represented, same principles apply at the encoding: slice_ts_residual_coding_disabled_flag is only encoded in the bitstream when sps_transform_skip_enabled_flag is set to 1 which specifies that transform_skip_flag could be present in the transform unit syntax.

According to another particular characteristic, the slice_ts_residual_coding_disabled_flag controlling RRC and TSRC with TrSkip enabled is therefore also used for ISP. Thus, decoding the block of the picture using entropy decoding applied to a residual of the block according to the obtained residual coding mode when intra sub-partition split type is set to no_split. This variant embodiment advantageously enables ISP for lossless mode. Indeed, due to the possible switching between RRC and TSRC, TrSkip can beneficially be enabled for lossless coding with ISP using RRC. The VVC specification is therefore modified as follows in the slice header (underlined):

| | Descriptor |
|---|---|
| transform_unit( x0, y0, tbWidth, tbHeight, treeType, subTuIndex, chType ) { | |
| ... | |
| if( tu_cbf_luma[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT \|\| | |
| slice_ts_residual_coding_disabled_flag) && !cu_sbt_flag) | |
| transform_skip_flag[ x0 ][ y0 ][ 0 ] | ae(v) |
| ... | |
| } | |
| ... | |
| } | |
| } | |

According to another particular characteristic, at least one syntax data element (sps_trskip_isp_enabled_flag) related to enabling transform skip of at least one region of a picture when intra sub-partition (ISP) is enabled is explicitly signaled. According to another particular characteristic, the at least one high level syntax element enabling transform skip in combination with ISP sps_trskip_isp_enabled_flag is signaled in the Sequence Parameter Set (SPS) so that all blocks in a sequence uses the signaled syntax element sps_trskip_isp_enabled_flag. Therefore, according to this characteristic, an additional SPS flag is added to enable the combination of TrSkip and ISP. According to a non-limiting example, this flag can be coded as follows:

| | Descriptor |
|---|---|
| seq_parameter_set_rbsp( ) { | |
| ... | |
| sps_isp_enabled_flag | u(1) |
| if (sps_isp_enabled_flag && | |
| sps_transform_skip_enabled_flag){ | |
| sps_trskip_isp_enabled_flag | u(1) |
| } | |
| ... | |
| } | |

And it is used in combination of slice_ts_residual_coding_disabled_flag in decoding residual as follows:

| | Descriptor |
|---|---|
| transform_unit( x0, y0, tbWidth, tbHeight, treeType, subTuIndex, chType ) { | |
| ... | |
| if( tu_cbf_luma[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT \|\| | |
| (slice_ts_residual_coding_disabled_flag && | |
| sps_trskip_isp_enabled_flag) ) && !cu_sbt_flag) | |
| transform_skip_flag[ x0 ][ y0 ][ 0 ] | ae(v) |
| ... | |
| } | |
| ... | |
| } | |
| } | |

In other words, the block of the picture is decoded using entropy decoding applied to a residual of the block according to the obtained residual coding mode (ie decoded from slice_ts_residual_coding_disabled_flag) when transform skip is enabled for ISP and intra sub-partition split type set to no_split as highlighted in grey. Advantageously, when sps_trskip_isp_enabled_flag is set to 0, TrSkip with ISP on RRC is not used.

According to a variant embodiment, the ISP-TrSkip combination is allowed for both RRC and TSRC. The combination ISP-TrSkip is thus advantageously enabled by a SPS flag for specific coding conditions (lossless for example), and depending on the content, RRC (for natural contents) or TSRC (for screen contents) can be used. As before, according to this variant embodiment, an additional SPS flag is added to enable the combination of TrSkip and ISP:

| | Descriptor |
|---|---|
| seq_parameter_set_rbsp( ) { | |
| ... | |
| sps_isp_enabled_flag | u(1) |
| if (sps_isp_enabled_flag && | |
| sps_transfom_skip_enabled_flag){ | |
| sps_trskip_isp_enabled_flag | u(1) |
| } | |
| ... | |
| } | |

Where the decoded flag is used as follows:

| | Descriptor |
|---|---|
| transform_unit( x0, y0, tbWidth, tbHeight, treeType, subTuIndex, chType ) { | |
| ... | |
| if( tu_cbf_luma[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplitType = = ISP_NO_SPLIT | |
| \|\| sps_trskip_isp_enabled_flag) && !cu_sbt_flag) | |
| transform_skip_flag[ x0 ][ y0 ][ 0 ] | ae(v) |
| ... | |
| } | |
| ... | |
| } | |
| } | |

According to another embodiment, a constraint flag for TSRC is signaled. Thus, when defining the profile, at least one syntax data element related to a constraint enabling transform skip coding mode (TRskip) is decoded and at least one syntax data element related to defining a constraint enabling transform skip residual coding mode (TSRC) when the constraint enables transform skip coding mode (TRskip) is further decoded. As mentioned before, there is some ambiguity in distinguishing between TrSkip as a method to bypass the transform and TrSkip as method for residual coding (TSRC). In fact, the current version of VVC does not allow defining a profile that skips the transform without implementing TSRC, although this configuration is available. Advantageously, the at least one embodiment adds another constraint flag to control TSRC, as follows:

| | Descriptor |
|---|---|
| general_constraint_info( ) { | |
| no_transform_skip_constraint_flag | u(1) |
| no_tsrc_constraint_flag | u(1) |
| ... | |
| } | |

While the added constraint flag no_tsrc_constraint_flag is defined as follows:

no_tsrc_constraint_flag equal to 1 specifies that slice_ts_residual_coding_disabled_flag shall be equal to 1.
no_transform_skip_constraint_flag equal to 0 does not impose such a constraint.

Advantageously, when the flag no_tsrc_constraint_flag is set to one, a profile is defined that allows Transform to be skipped and RRC used for residual coding. Besides, when the flag no_tsrc_constraint_flag is set to one, a profile is defined that further allows enabling BDPCM although TSRC is disabled.

According to a version of VVC specification, the slice level for disabling TSRC is conditioned on the transform skip SPS flag, and the quantization type. This is because both dependent quantization and sign data hiding cannot be used with RRC, and only TSRC is used. In this version of VVC specification, header flags are renamed. According to non-limiting examples slice header flag uses prefix sh_, picture header flag uses prefix ph_. Thus in the following slice_ts_residual_coding_disabled_flag and sh_ts_residual_coding_disabled_flag are used indifferently. The corresponding specification text is:

| | Descriptor |
|---|---|
| slice_header( ) { | |
| ... | |
| if( sps_dep_quant_enabled_flag) | |
| sh_dep_quant_enabled_flag | u(1) |
| if( sps_sign_data_hiding_enabled_flag && | |
| !sh_dep_quant_enabled_flag) | |
| sh_sign_data_hiding_enabled_flag | u(1) |
| if( sps_transform_skip_enabled_flag && | |
| !sh_dep_quant_enabled_flag && | |
| !sh_sign_data_hiding_enabled_flag) | |
| sh_ts_residual_coding_disabled_flag | u(1) |
| ... | |

That is, when either dependent quantization or sign data hiding is enabled for the current slice (sh_dep_quant_enabled_flag=1 or sh_sign_data_hiding_enabled_flag=1), TSRC is enabled by default since sh_ts_residual_coding_disabled_flag is not signaled but inferred to be zero. An issue occurs when transform skip is disabled (sps_transform_skip_enabled_flag=0), which means that no transform skip is used and therefore TSRC is disabled by default. However, the inferred value of sh_ts_residual_coding_disabled_flag remains zero (TSRC is not disabled) and the constraint flag no_tsrc_constraint_flag cannot be set to one, although TSRC is never used. That is, the constraint flag cannot represent the actual profile.

At least two variant embodiments are described solving this issue. The first embodiment comprising modifying the inference role of sh_ts_residual_coding_disabled_flag such that when transform skip is disabled, TSRC is disabled. The change to the specification is (highlighted in grey):

sh_ts_residual_coding_disabled_flag equal to 1 specifies that the residual_coding( ) syntax structure is used to parse the residual samples of a transform skip block for the current slice. sh_ts_residual_coding_disabled_flag equal to 0 specifies that the residual_ts_coding( ) syntax structure is used to parse the residual samples of a transform skip block for the current slice. When sh_ts_residual_coding_disabled_flag is not present, it is inferred to be equal to !sps transform skip enabled flag.

By doing so, when sh_ts_residual_coding_disabled_flag is not signaled, it is inferred to be equal to 1 (no TSRC) when transform skip is disabled (sps_transform_skip_enabled_flag=0), or inferred to be 0 (TSRC is used) when transform skip is enabled.

The second embodiment comprises modifying the semantics of the constraint flag. That is, no_tsrc_constraint_flag is set to one when either sh_ts_residual_coding_disabled_flag is equal to one or sps_transform_skip_enabled_flag is zero. The change to the specification is as follows:

no_tsrc_constraint_flag equal to 1 specifies that sh_ts_residual_coding_disabled_flag shall be equal to 1 or
sps_transform_skip_enabled_flag shall be equal to 0. no_transform_skip_constraint_flag equal to 0 does not
impose such a constraint.

According to a variant embodiment of the constraint flag, an SPS level flag to control TSRC-RRC switching. That is, in the SPS, the following can be added (underlined):

| | Descriptor |
|---|---|
| seq_parameter_set_rbsp( ) { | |
| ... | |
| sps_transform_skip_enabled_flag | u(1) |
| if( sps_transform_skip_enabled_flag ) { | |
| log2_transform_skip_max_size_minus2 | ue(v) |
| sps_tsrc_disabled_flag | u(1) |
| ... | |
| } | |
| ... | |
| } | |

This flag is inferred to zero if not coded. If it is one, TSRC is disabled. The same slice level flag is used to control TSRC-RRC switching:

| | Descriptor |
|---|---|
| slice_header( ) { | |
| ... | |
| if (!sps_tsrc_disabled_flag) { | |
| slice_ts_residual_coding_disabled_flag | u(1) |
| } | |
| ... | |
| } | |

And the constraint flag is designed as:

| | Descriptor |
|---|---|
| general_constraint_info( ) { | |
| no_transform_skip_constraint_flag | u(1) |
| no_tsrc_constraint_flag | u(1) |
| ... | |
| } | |

And its semantic:

no_tsrc_constraint_flag equal to 1 specifies that sps_tsrc_disabled_flag shall be equal to 1.
no_transform_skip_constraint_flag equal to 0 does not impose such a constraint.

In a variant of at least some of the embodiments described above, that can help to reduce the signaling overhead, this constraint flag (no_tsrc_constraint_flag) can be conditioned on the transform skip constraint flag.

In other words, if we know that transform skip is deactivated by its constraint flag, it is useless to further signal via a constraint flag that TSRC is deactivated because TSRC is not used in this case.

For instance, in an exemplary use case like VVC, where the constraint flag for transform skip is named “no_transform_skip_constraint_flag”, we can condition “no_tsrc_constraint_flag” in the following manner:

| | Descriptor |
|---|---|
| general_constraint_info( ) { | |
| ... | |
| no_transform_skip_constraint_flag | u(1) |
| if (no transform skip constraint flag == 0) | |
| no_tsrc_constraint_flag | u(1) |
| ... | |

The semantic of no_tsrc_constraint_flag can for instance be expressed as:

no_tsrc_constraint_flag equal to 1 specifies that sps_tsrc_disabled_flag shall be equal to 1.
no_transform_skip_constraint_flag equal to 0 does not impose such a constraint. If not available, the value
no_tsrc_constraint_flag shall be inferred to 1.

To adapt this SPS flag to the current VVC specification, the following change is made (strikethrough and highlighted in grey):

| | Descriptor |
|---|---|
| slice_header( ) { | |
| ... | |
| if( sps_dep_quant_enabled_flag ) | |
| sh_dep_quant_enabled_flag | u(1) |
| if( sps_sign_data_hiding_enabled_flag && !sh_dep_quant_enabled_flag ) | |
| sh_sign_data_hiding_enabled_flag | u(1) |
| if( [symbol] !sps tsrc disabled flag && | |
| !sh_dep_quant_enabled_flag && | |
| !sh_sign_data_hiding_enabled_flag ) | |
| sh_ts_residual_coding_disabled_flag | u(1) |
| ... | |

The inference roles for sps_tsrc_disabled_flag and sh_ts_residual_coding_disabled_flag shall be like this:
When sps_tsrc_disabled_flag is not signaled, it is inferred to be 1, so that when transform skip is disabled TSRC is disabled and the constraint flag (no_tsrc_constraint_flag) is correctly set.
When sh_ts_residual_coding_disabled_flag is not signaled, it is inferred to be equal to zero.

In another embodiment, when no_tsrc_constraint_flag equals to one, which indicates that TSRC is not used, dependent quantization and sign data hiding shall be deactivated as they cannot be used with RRC. Therefore, when no_tsrc_constraint_flag is equal to one, no_dependent_quant_constraint_flag and no_sign_data_hiding shall be one as well. The corresponding change to the specification, uniquely for the semantics of “no_dependent_quant_constraint_flag and no_sign_data_hiding”, is:

no_dep_quant_constraint_flag equal to 1 specifies that sps_dep_quant_enabled_flag shall be equal to 0. no_dep_quant_constraint_flag equal to 0 does not impose such a constraint. When no_tsrc_constraint_flag is equal to one, the value of no_dep_quant_constraint_flag shall be equal to one.

no_sign_data_hiding_constraint_flag equal to 1 specifies that sps_sign_data_hiding_enabled_flag shall be equal to 0. no_sign_data_hiding_constraint_flag equal to 0 does not impose such a constraint. When no_tsrc_constraint_flag is equal to one, the value of no_sign_data_hiding_constraint_flag_shall be equal to one.

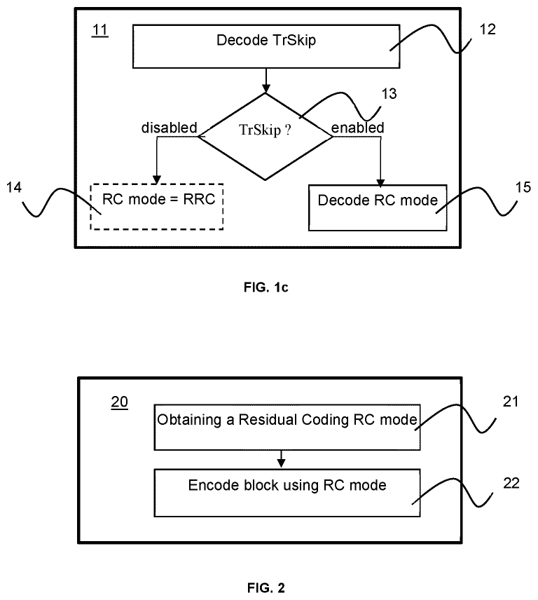

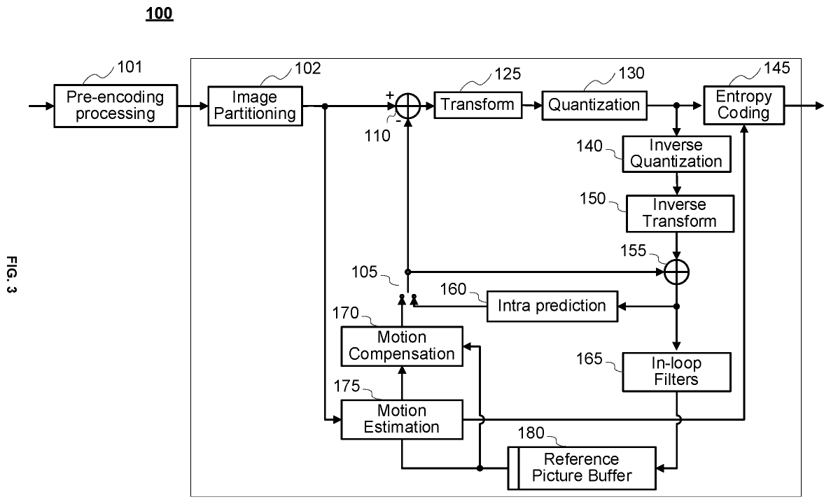

FIG. 2 illustrates an example of coding method according to a general aspect of at least one embodiment. The above described embodiments for signaling/deriving transform tools and coding modes are compatible with the encoding method and will be easily combined for implementing various embodiments of an encoding method. Thus, the method 20 for encoding a block (for example a Coding Unit CU) in a picture comprises, in a step 21, obtaining a residual coding mode, RC mode. As previously described, the residual coding mode is one of regular residual coding mode RRC or transform skip residual coding mode TSRC. The RC mode is applied while coding 22 the block of the picture to control entropy coding of a residual of the block. According to a particular characteristic, the residual coding mode is set by default to regular residual coding mode RRC when transform skip is disabled. This embodiment advantageously avoids coding slice_ts_residual_coding_disabled_flag if transform skip is disabled. According to another particular characteristic, the residual coding mode is either set to regular residual coding mode RRC or to transform skip residual coding mode TSRC when transform skip is enabled. Then, the residual coding mode RRC or TSRC is encoded in slice_ts_residual_coding_disabled_flag when transform skip is enabled. Advantageously, the encoded flag allows the decoder to perform the decoding of residuals that corresponds to the encoding method.

Additional Embodiments and Information

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 3, 4 and 5 below provide some embodiments, but other embodiments are contemplated and the discussion of FIGS. 3, 4 and 5 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined.

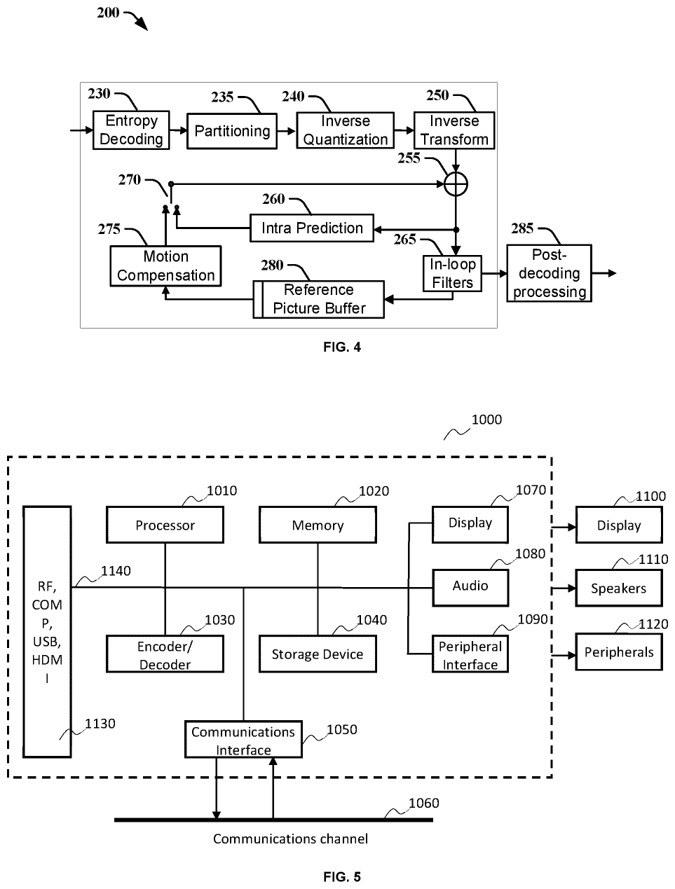

Various methods and other aspects described in this application can be used to modify modules, for example, the transform modules (125, 250) of a video encoder 100 and decoder 200 as shown in FIG. 3 and FIG. 4. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example the value of the flags. The specific values are for example purposes and the aspects described are not limited to these specific values. Names of variables, for instance flag names, are also only presented in an exemplary purpose.

FIG. 3 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 4 illustrates a block diagram of a video decoder 200. In the decoder 200, a bitstream is decoded by the decoder elements as described below. Video decoder 200 generally performs a decoding pass reciprocal to the encoding pass as described in FIG. 3. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 5 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules.

Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television.

In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 5, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decoding the block of the picture according to the residual coding mode wherein the residual coding mode is set to regular residual coding mode (RRC) when transform skip is disabled.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, coding the block of the picture according to the residual coding mode wherein the residual coding mode is set to regular residual coding mode (RRC) when transform skip is disabled and the encoding of the residual coding mode is skipped.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for matrix based intra prediction. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
SDP (session description protocol), a format for describing multimedia communication sessions for the purposes of session announcement and session invitation, for example as described in RFCs and used in conjunction with RTP (Real-time Transport Protocol) transmission;
DASH MPD (Media Presentation Description) Descriptors, for example as used in DASH and transmitted over HTTP, a Descriptor is associated to a Representation or collection of Representations to provide additional characteristic to the content Representation;
RTP header extensions, for example as used during RTP streaming;
ISO Base Media File Format, for example as used in OMAF and using boxes which are object-oriented building blocks defined by a unique type identifier and length also known as ‘atoms’ in some specifications;
HLS (HTTP live Streaming) manifest transmitted over HTTP. A manifest can be associated, for example, to a version or collection of versions of a content to provide characteristics of the version or collection of versions.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Modifying an encoding/decoding of a block of a picture of a video, the block being coded/decoded according to a residual coding mode wherein the residual coding mode is set to regular residual coding mode (RRC) when transform skip is disabled;
Modifying an encoding/decoding of a block of a picture of a video, the block being coded/decoded according to a residual coding mode wherein at least one syntax data element related to a residual coding mode of a block of a picture is encoded/decoded when transform skip is enabled;
Modifying an encoding/decoding of a block of a picture of a video combining residual coding mode with intra sub-partition.
Inserting in the signaling, at least one syntax data element related to enabling transform skip of at least one region of a picture when intra sub-partition (ISP) is enabled and transform skip is enabled;
Inserting in the signaling, at least one syntax data element related to defining a constraint enabling transform skip residual coding mode (TSRC);
A bitstream or signal that includes one or more of the described syntax elements, or variations thereof.
A bitstream or signal that includes syntax conveying information generated according to any of the embodiments described.
Inserting in the signaling syntax elements that enable the decoder to process TRSkip and residual coding modes in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs transform skip and residual coding according to any of the embodiments described.
A TV, set-top box, cell phone, tablet, or other electronic device that performs transform skip and residual coding according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs transform skip and residual coding according to any of the embodiments described.
A TV, set-top box, cell phone, tablet, or other electronic device that receives (e.g. using an antenna) a signal over the air that includes an encoded image, and performs transform skip and residual coding according to any of the embodiments described.

1. A method, comprising:
decoding a syntax element indicating that transform skip data are present in a bitstream; and
responsive to transform skip data being present, decoding at least one syntax data element related to a residual coding mode of a block of a picture, wherein the residual coding mode is one of regular residual coding mode or transform skip residual coding mode.

2.-21. (canceled)

22. The method according to claim 1, wherein the transform skip residual coding mode adapts a CABAC entropy coding of a spatial transform skip residual block to screen-content-coding in near lossless coding or lossless coding.

23. The method according to claim 1, wherein the residual coding mode adapts a CABAC entropy coding of a spatial transform skip residual block to camera captured content coding in near lossless coding or lossless coding.

24. An apparatus, comprising one or more processors, wherein the one or more processors are configured to:
decode a syntax element indicating that transform skip data are present in a bitstream; and
responsive to transform skip data being present, decode at least one syntax data element related to a residual coding mode of a block of a picture, wherein the residual coding mode is one of regular residual coding mode or transform skip residual coding mode.

25. The apparatus according to claim 24, wherein the transform skip residual coding mode adapts a CABAC entropy coding of a spatial transform skip residual block to screen-content-coding in near lossless coding or lossless coding.

26. The apparatus according to claim 24, wherein the residual coding mode adapts a CABAC entropy coding of a spatial transform skip residual block to camera captured content coding in near lossless coding or lossless coding.

27. A method, comprising:
encoding a syntax element indicating that transform skip data are present in a bitstream; and
responsive to transform skip data being present, encoding at least one syntax data element related to a residual coding mode of a block of a picture, wherein the residual coding mode is one of regular residual coding mode or transform skip residual coding mode.

28. The method according to claim 27, wherein the transform skip residual coding mode adapts a CABAC entropy coding of a spatial transform skip residual block to screen-content-coding in near lossless coding or lossless coding.

29. The method according to claim 27, wherein the residual coding mode adapts a CABAC entropy coding of a spatial transform skip residual block to camera captured content coding in near lossless coding or lossless coding.

30. An apparatus, comprising one or more processors, wherein the one or more processors are configured for:
encode a syntax element indicating that transform skip data are present in a bitstream; and
responsive to transform skip data being present, encode at least one syntax data element related to a residual coding mode of a block of a picture, wherein the residual coding mode is one of regular residual coding mode or transform skip residual coding mode.

31. The apparatus according to claim 30, wherein the transform skip residual coding mode adapts a CABAC entropy coding of a spatial transform skip residual block to screen-content-coding in near lossless coding or lossless coding.

32. The apparatus according to claim 30, wherein the residual coding mode adapts a CABAC entropy coding of a spatial transform skip residual block to camera captured content coding in near lossless coding or lossless coding.

33. A non-transitory computer readable medium comprising program code instructions to execute the method of claim 1 when executed on a computer.

34. A non-transitory computer readable medium comprising program code instructions to execute the method of claim 27 when executed on a computer.

35. A non-transitory computer readable medium containing data content encoded thereupon, comprising:
a syntax element indicating that transform skip data are present; and
at least one syntax data element related to a residual coding mode of a block of a picture, wherein the residual coding mode is one of regular residual coding mode or transform skip residual coding mode.

36. The non-transitory computer readable medium according to claim 35, wherein the transform skip residual coding mode adapts a CABAC entropy coding of a spatial transform skip residual block to screen-content-coding in near lossless coding or lossless coding.

37. The non-transitory computer readable medium according to claim 35, wherein the residual coding mode adapts a CABAC entropy coding of a spatial transform skip residual block to camera captured content coding in near lossless coding or lossless coding.
